(19) United States
(12) Patent Application Publication
(10) Pub. No.: US 2020/0334595 A1
(43) Pub. Date: Oct. 22, 2020

(54) COMPANY SIZE ESTIMATION SYSTEM

(71) Applicant: The Dun & Bradstreet Corporation, Short Hills, NJ (US)

(72) Inventors: Nikita ZHILTSOV, San Jose, CA (US); Maria GRINEVA, San Jose, CA (US); Aleksandr BOLDAKOV, San Jose, CA (US)

(21) Appl. No.: 16/389,095

(22) Filed: Apr. 19, 2019

(51) Int. Cl. G06Q 10/06; G06N 20/00

(52) U.S. Cl. CPC G06Q 10/067; G06N 20/00

(57) ABSTRACT

A company size estimation (CSE) system predicts employee number ranges for companies based on information available in open government and website sources. The CSE system breaks down the problem into two consecutive machine learning tasks. A first operation identifies large companies and a second operation identifies employee number ranges for small and medium-sized companies. Both operations take advantage of a rich set of firmographic attributes collected for companies, such as industry codes, office locations, corporate website text, website traffic, social media presence, and discoverability with respect to various data sources.

### BACKGROUND

Automated estimation of a company size is an important part of various business applications. In business-to-business (B2B) sales, automated lead (potential customer) qualification and scoring relies on the information available about the given sales lead. In the typical scenario, a B2B company receives a steady stream of inbound inquiries from leads through the company website. It is important to qualify the inbound leads before a sales representative starts engaging with them, as it saves the company resources and improves the customer experience. In B2B marketing, total addressable market estimation and market segmentation is often performed based on the company revenue or employment size.

The approval of small business loans applications is another example. Lending institutions collect as much information about the company as possible in order to assess its credit risk. In the case of small business lending, information collection is performed automatically and company size is one of the critical data points.

### BRIEF DESCRIPTION OF THE DRAWINGS

FIG. 1 depicts an example company size estimation (CSE) system.

FIG. 2 depicts an example process used by the CSE system of FIG. 1 for predicting company sizes.

FIGS. 3A and 3B depict example features generated by the CSE system for predicting company size.

FIGS. 4 and 5 depict how the CSE system converts census data into company size probabilities.

FIG. 6 depicts an example computing device used for implementing the CSE system.

### DETAILED DESCRIPTION

A company size estimation (CSE) system predicts employee number ranges for companies based on information available in open government and website sources. The CSE system breaks down the problem into two consecutive machine learning tasks. A first machine learning model identifies large companies and a second machine learning model identifies employee number ranges for small and medium-sized companies.

Both operations take advantage of a rich set of firmographic attributes collected for companies, such as industry codes, office locations, corporate website text, website traffic, social media presence, and discoverability with respect to various data sources.

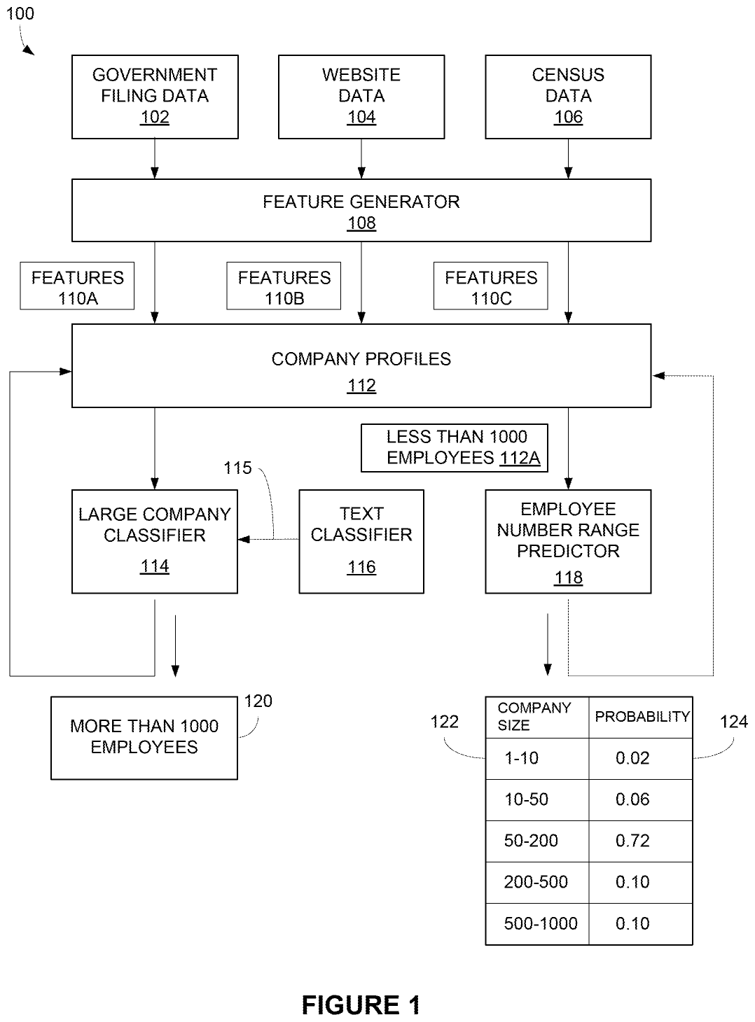

Referring to FIG. 1, company size estimation (CSE) system 100 collects data from different sources. In one example, CSE system 100 collects data 102 from document filed by companies with different government agencies. For example, government filing data 102 may include publically available documents filed by companies and published by various United States federal and state level government agencies, such as the Department of Labor, Internal Revenue Service (IRS), Securities and Exchange Commission, and secretary of state offices.

Government filing data 102 may include any document filed by a company with any agency or any other document otherwise associated with a company. In one example, the government documents may be filed in association with countries, states, cities, counties, or any other municipality. In one example described below, the government entities are located in the United States. However, it should be understood that the government filing data 102 may be associated with any government, nation, state, province, county, city, municipality, or any other entity located in the world.

When allowed, CSE system 100 may also collect website data 104 from websites operated by particular companies. Any combination of company operated websites may be used for obtaining website data 104.

CSE system 100 also may collect census data 106 from any publically available source, such as the United States Census Bureau (census.gov). Census data 106 for the United States may include business statistics, such as the number of companies within different employee number ranges for different industries located in different states. Of course CSE system 100 also may use census data 106 from other countries.

A feature generator 108 generates different features 110A, 110B, and 110C from data 102, 104, and 106, respectively. For example, feature generator 108 may generate a feature 110A from government filing data 102 that identifies the number of different business addresses for a particular company. Feature generator 108 combines features 110 associated with the same company into a same company profile 112. For example, feature generator 108 may store any combination of features 110A, 110B, and 110C associated with the same company name and address in the same company profile 112. Feature generator 108 may use any fuzzy name matching, hand-crafted matching rules, and manual data reviews to determine which features 110 as associated with the same company.

Feature generator 108 may use any method to obtain government filing data 102, website data 104, and census data 106. For example, feature generator 108 may use application programming interfaces (APIs) or web crawlers to access content on different government, and company websites. Other data 102, 104, or 106 may be supplied by applications that monitor and accumulate metrics for different websites. Other data 102, 104, or 106 may be obtained via documents sent by different government agencies or businesses.

Feature generator 108 parses data 102, 104, and 106 for different features 110A, 110B, and 110C that may have some association with company size. For example, feature generator 108 may parse government filing data 102 to identify a number of business locations for a particular company. A larger number of business locations may indicate a larger company size. Feature generator 108 may convert the number of company business locations into a feature 110A.

Feature generator 108 also may parse website data 104 to identify different content in the websites and characteristics of the websites that relate to company size. For example, a larger number of websites operated by a same company and a larger number of social media websites used by the same company may indicate a larger company size. Feature generator 108 generates another set of website features 110B based on the content and characteristics of websites that may be associated with company size.

Feature generator 108 also may parse publically available census data 106 from the United States Census Bureau for any other company size data. For example, census data 106 may list by employee number range, the number of companies in different industries. Feature generator 108 may convert the census numbers into an employee number range probability feature 110C.

Feature generator 108 uses company names, email addresses, physical addresses, industry classifications, etc. in government filing data 102, website data 104, and census data 106 to link features 110A, 110B, and 110C for the same company to a same company profile 112.

A large company classifier 114 uses a set of features 110 from company profiles 112 to distinguish large companies from medium and small size companies. For example, large company classifier 114 may use a set of features 110, such as founding year of the company, website domain ranking, and boolean flags indicating presence of corporate accounts on LinkedIn®, Facebook®, and Twitter®.

Other features 110 used by large company classifier 114 may include a neighbor count identifying a number of companies sharing the same location address with the given company and types of webpages on the company website, such as a contacts page, jobs page, products page, terms page, and investor page. Large company classifier 114 also may use features 110 that identify the types of software technologies used on the company website. These and other features 110 used by large company classifier 114 are described in more detail below.

Large company classifier 114 also may use a text classifier 116 to identify large sized companies based on text contained in company webpages. For example, webpages on the company website may include words, such as “international headquarters”, “European Office”, “global leader”, etc. associated with a large company size. Webpages on other company websites include words, such as local, restaurant, cleaning, etc. associated with a smaller company size.

Text classifier 116 may accept word vectors obtained from some word2vector generator from the text in the company webpages as an input. Example word2vector generators used in text classifier 116 may include Facebook's FastText, Google's word2vec and Fast.ai's language model learner. In one example, standard tokenization and stop word filtering are performed use a Python NLTK package. Text classifier 116 outputs a text-based probability score 115, this score is a probability of the given company being large. The score is then provided as input to large company classifier 114.

In one example, the computer learning model used in text classifier 116 is a feed-forward neural network, such as FastText. During training, the neural network jointly learns word embeddings and hidden layer weights, fitting them to separate descriptions of large companies from ones of small companies. For example, the neural network automatically detects meaningful words and phrases that attribute to large and small companies.

The computer learning model in large company classifier 114 uses text-based probability score 115 from text classifier 116 and features 110 from company profiles 112 as inputs. Large company classifier 114 may generate a binary output indicating whether each company profile 112 is a large company or is not a large company. In one example, any company having more than 1000 employees is considered a large company. However, this is just one example, and any number of employees may be used as the threshold for large companies. Large company classifier 114 may assign tags 120 to company profiles 112 identified as large companies.

Any company profiles 112A not tagged as large companies are further classified by an employee number range predictor 118. Company profiles tagged as large companies may be passed for review to a team of data editors. The data editors may review the company information and research it on the Web and may manually assign correct number of employees. Information on number of employees for large companies may be available on the Web, such as in public reports, press releases or Wikipedia.

In one example, range predictor 118 classifies company profiles 112A into 5 different employee size ranges 122 as shown in table 1.0 below. However, this is just one example, and any number of employee size ranges can be used.

```
TABLE 1.0
EMPLOYEE
COMPANY
SIZE
RANGES
  1-10
10-50
  50-200
200-500
  500-1000
```

Some of the same features 110 used by large company classifier 114 are used as inputs for employee range predictor 118. However, in one example, predictor 118 may or may not use Text-based probability scores 115 generated by text classifier 116 and may use additional features generated from census data 106.

For each company profile 112A, predictor 118 may predict a company size range 122 and an associated probability 124. For example, predictor 118 may determine a particular company profile 112A has a 0.02 probability of having 1-10 employees, a 0.06 probability of having 10-50 employees, a 0.72 probability of having 50-200 employees, a 0.10 probability of having 200-500 employees, and a 0.10 probability of having 500-1000 employees.

Employee number range predictor 118 may calculate and identify probabilities 124 for each of to the five employee number ranges 122 or may only calculate and identify the employee number range 122 with the highest probability 124. Either way, employee number range predictor 118 may add the identified employee number range 122 and probability 124 to the associated company profile 112A. There could be a filter at the end of range predictor 118 that removes any predictions 122 with a probability 124 below a particular threshold.

Employee number range predictor 118 may convert range classifications into a regression problem by calculating values for each employee number range 122. For example, the smallest employee number range of 1-10 employees is converted into the value (10+1)/2=5.5. Company size ranges 10-50, 50-200, 200-500, and 500-1000 are converted respectively into the following values: (10+50)/2=30; (50+200)/2=125; (200+500)/2=350; and (500+1000)/2=750.

As mentioned above, census data 106 for the United States may include a state and North America Industry Classification System (NAICS) industry code. Feature generator 108 may assign similar state and NAICS codes to each company profile 112 identified from government documents 102 and/or website data 104.

Feature generator 108 may compute separate likelihood estimates for each employee number range 122 based on the number of companies in census data 106 that fall into ranges 122. This prior knowledge in census data 106 identifies the distribution of company sizes by industry and location and can serve as a bias for employee number range predictor 118.

For example, the probabilities generated from census data 106 may indicate as an information technology company (NAICS code 51) in California may be more likely to have between 1-10 employees (80.0% probability), compared to an information technology company in Texas (70.5% probability). Employee number range predictor 118 may use the census probabilities to make initial guesses as to the employee number range 122 for company profiles 112 or may use the census probabilities to adjust calculated probabilities 124.

In one example, employee number range predictor 118 may use a machine learning model, such as a linear regression model such as Lasso, ridge regression, RandomForest, Gradient Boosted Regression Trees (GBRT), XGBoost, Cat-Boost, or LightGBM. Of course these are just examples and any machine learning model for regression or classification may be used for predicting company size ranges 122 and associated probabilities 124.

As mentioned above, the six company ranges obtained as a result of running both large company classifier 114 and employee number range predictor 118, can be used by any entity that needs information regarding the approximate size of a company. For example, a bank may use employee number range predictions 120 and 122 to decide whether or not to approve a loan or to determine a loan rate. The bank can also use a history of size predictions 120 and 122 to discover company growth patterns. If the company shows a history of growth, the bank may be more inclined to approve the loan request.

Company size predictions 120 and 122 may be used for lead qualification. For example, a particular salesman may only sell products to mid-size companies. The company size predictions 120 and 122 can be used to filter out leads that are not identified as mid-size companies.

Company size predictions 120 and 122 can also help estimate potential sales revenues. For example, a salesman that sells employee/user software or employee benefits can use size estimations 120 and 122 to estimate the number of potential software licenses or benefit services that can be sold to a particular company.

Company size predictions 120 and 122 can also be used for data verification. For example, a service such as LinkedIn® may want to verify their user-generated company size data. These business information companies may compare their user-generated company size data with company size predictions 120 and 122 to confirm data accuracy.

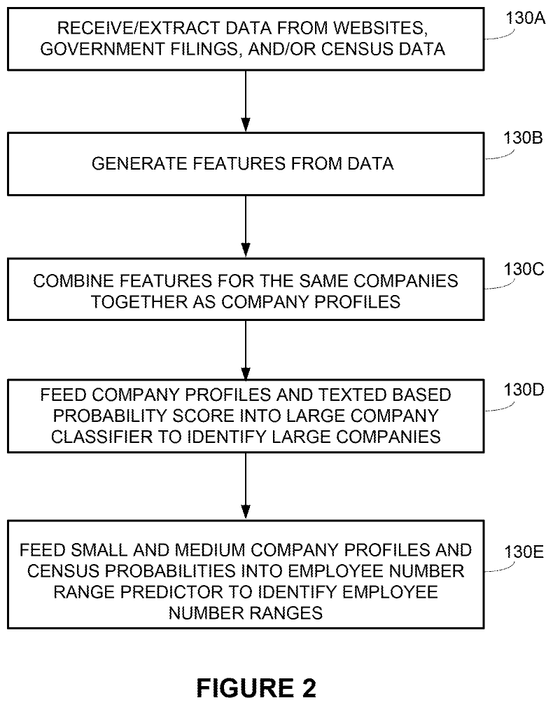

FIG. 2 shows in more detail the operations performed by CSE system 100. Referring to FIGS. 1 and 2, in operation 130A, CSE 100 receives or extracts government filing data 102, website data 104, and/or census data 106. As explained above, some data may be extracted from websites or databases via APIs and other data may be provided by applications that monitor and extract data from the websites. For example, a service, such as Alexa®, may rank websites based on the number of visitors to the website.

Operation 130B generates features 110 from the data 102, 104, and 106. For example, CSE system 100 may generate a value based on the Alexa® ranking for the company website. The value is used as a number of visitors feature in the company profile 112. Operation 130C combines features 110 for the same company together into a same company profile 112. Features 110 may be normalized into similar data ranges. Features 110 also may include topic vectors 115 generated by text classifier 116.

Operation 130D feeds company profiles 112 and topic vectors 115 into large company classifier 114. Large company classifier 114 predicts which company profiles 112 are associated with large companies with more than 1000 employees. Large company classifier 114 may attach large company labels 120 to company profiles 112 predicted as having more than 1000 employees.

Operation 130E feeds company profiles 112A and census probabilities into employee number range predictor 118. Range predictor 118 predicts employee number ranges 122 for company profiles 112A and may also generate probability values 124 indicating confidence levels for predicted employee number ranges 122. Predicted employee number ranges 122 also may be attached as labels to company profiles 112A.

### Features

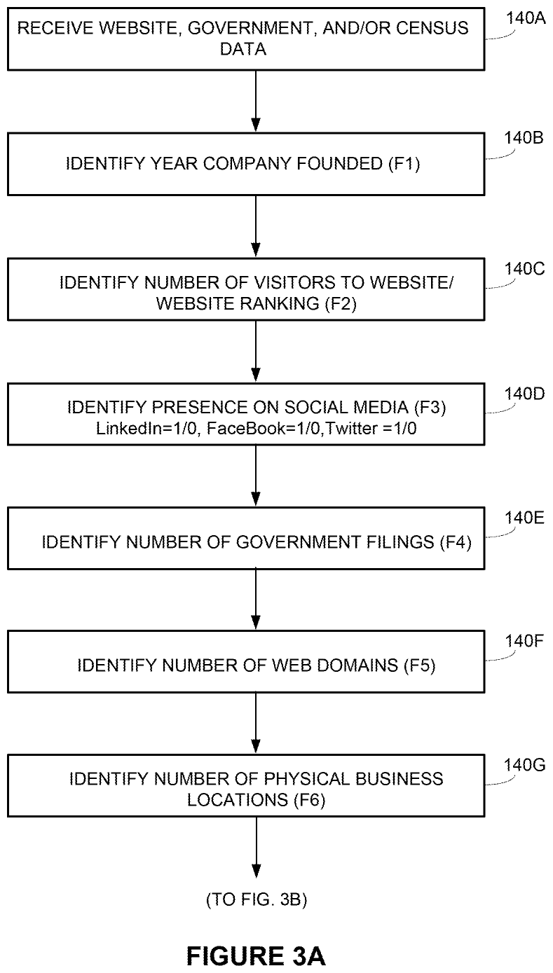

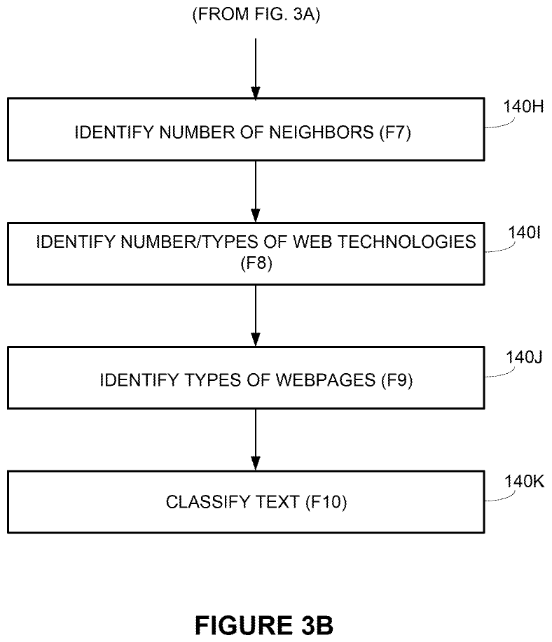

FIGS. 3A and 3B explain in more detail some of the features 110 generated by feature generator 108 in FIG. 1. Referring to FIGS. 1, 3A, and 3B, feature generator 108 in operation 140A receives government filing data 102, website data 104, and census data 106. The different data sources may be scanned periodically and automated and manual processes used to verify data validity.

Feature F1: Year Company Founded

Feature generator 108 in operation 140B may generate feature F1 identifying a year the company was founded. The year a company was founded may be extracted from government filing data 102 or from website data 104. For example, Security and Exchange commission filings and state incorporation documents may identify the year of incorporation for a company. Other business filing with the secretary of state also may identify the year a company was established.

Feature F2: Number of Website Visitors.

Feature generator 108 in operation 140C may generate feature F2 identifying a number of visitors to a company website. Feature F2 may be any number indicating the popularity of a website operated by a company. As mentioned above, applications such as Alexa® may rank websites based on number of visitors. Feature generator 108 may convert the website rankings into normalized values between 1 and 0 based on ranking position and may assign the normalized value to the company profile 112 for the company that operates the website.

Feature F3: Presence on Social Media.

Feature generator 108 in operation 140D may generate feature F3 identifying a presence of the company on social media. In one example, feature generator 108 may determine IF companies have accounts on certain social media websites. If so, feature generator 108 may generate 1 values in different vector fields. For example, feature generator 108 may generate binary values that indicate a company has accounts on different social media websites, such as LinkedIn=0/1, Facebook=0/1, and Twitter=0/1. Of course, any other website may be searched to further determine the social media presence of the company.

Feature F4: Number of Government Filings.

Feature generator 108 in operation 140E may generate feature F4 identifying a number of government filings by the company. As mentioned above, government filings are not limited to documents filed at city, state, and federal levels in the United States. Government filings also may include filing in any other country, such as in the United Kingdom (UK) filings, European Union (EU), etc. Feature generator 108 may obtain or identify the government filings from publically accessible databases operated by different government agencies.

Examples of government filings may include, but are not limited to, filings related to employee benefits, SEC, homeland security for visas, non-profits, legal, medical, farming, limited liability corporations (LLCs), etc. Some of the government filings may include NAICS codes associated with a hierarchy of industry categories. The number and types of government filings may serve as a predictor of company size. Feature generator 108 may generate a number proportional to the number of these government filings by a company. In another example, feature generator 108 may generate binary vector values each indicating existence/non-existence of a different government filing.

Feature F5: Number of Web Domains.

Feature generator 108 in operation 140F may generate feature F5 identifying the number of websites/web domains owned and/or operated by each company. For example, a company may have separate websites for different products and/or organizations. Feature generator 108 may crawl a company website or government documents for links and names of other entities. For example, the home page of a company website may include links to other websites owned by the same company. Government documents and website domain registries also may include company names and addresses for domain names owned by the same company.

Feature F6: Number of Business Locations.

Feature generator 108 in operation 140G may generate feature F6 identifying a number of different physical business addresses associated with the same company. For example, each time a company moves into a new business address, the business name and address may be filed in the secretary of state office. In another example, the company website may list the different corporate addresses for the company. Feature generator 108 may crawl the secretary of state documents and company website pages identifying the number of different physical business locations for the company. As with other features, feature generator 108 may normalize the number of business locations and save the normalized number as a vector value.

Feature F7: Number of Neighbors.

Feature generator 108 in operation 140H may generate feature F7 identifying a number of neighbors of the company. Feature generator 108 may consider two companies that share a same address as neighbors. A higher number of company neighbors may indicate a generally smaller company and a lower number of company neighbors may indicate a larger company. Feature generator 108 may identify the company addresses from any of the government documents 102 or website data 104. Feature generator 108 then may compare the company addresses in all of the company profiles 112 and identify any companies with the same address as neighbors.

Feature F8: Number/Types of Website Technologies.

Feature generator 108 in operation 140i may generate feature F8 identifying the number or types of website technologies used on the company website. Website technologies are alternatively referred to as technographics. A company website may use different software tools each having an associated cost. For example, a company website may use web analytics software such as Google Analytics® (free), form application software such as Mailchimp® (medium cost), and sales and marketing software such as Salesforce® or Marketo® (high cost).

Feature generator 108 may identify a priori the cost of different web based software tools as free, medium, or expensive. Feature generator 108 may use a web crawler to identify the software tools operating on company websites and assign binary labels to the identified software tools as free=1/0, medium=1/0, or expensive=1/0. Feature generator 108 may generate feature F8 that identifies the number of software tools in each cost category. Feature F8 may indicate company software sophistication where more expensive software tools may correspond with a larger more mature company.

Feature F9: Types of Webpages.

Feature generator 108 in operation 140J may generate feature F9 identifying types of webpages on the company website. Feature generator 108 may crawl company websites for particular type of webpages or links to those webpages. For example, a company website may include a corporate information webpage, a job posting webpage, a contact webpage, an investor relations webpage, a legal-terms webpage, and a blog webpage. The existence of these webpages may indicate company size. For example, public traded companies may be required to provide a corporate information webpage on their website. A job posting webpage may indicate a larger company. Feature generator 108 may create a feature vector F9 that uses binary values to represent the existence of each one of these different types of webpages.

Feature F10: Text-Based Probability Score.

Text classifier 116 in operation 140K may generate text-based probability score F10 representing a probability of the given company being large. Certain words used in the webpages may correspond to a company size. For example, words and phrases such as “big company”, “different continents”, “countries”, “global leader”, “international presence”, “civil engineering”, “European office”, etc. may correspond with larger companies. Words or phrases such as local, restaurant, cleaning, etc. may correspond with smaller companies.

In one example, text-based probability score 115 are generated by text classifier 116 and input into large company classifier 114. In another example, text-based probability score 115 may or may not be used in employee number range predictor 118. It should also be understood that any of features F1-F10, or any other features, can be used as inputs for either large company classifier 114 or employee number range predictor 118.

### Census Data (Prior Knowledge)

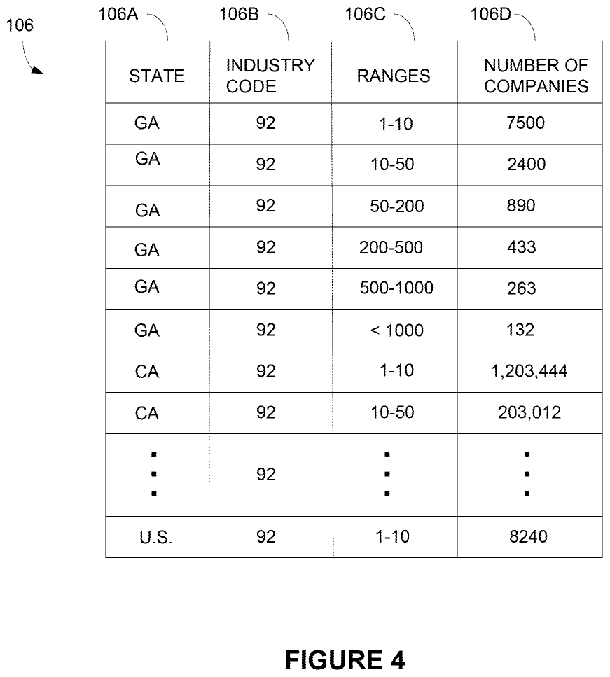

FIG. 4 shows example census data 106 received by feature generator 108. Census data 106 includes state identifiers 106A, industry codes 106B, and employee size ranges 106C. Census data 106 also identifies a number of companies 106D for each of the specified states 106A, industry codes 106B, and employee size ranges 106C. All census data 106A-106D is supplied in a government census.

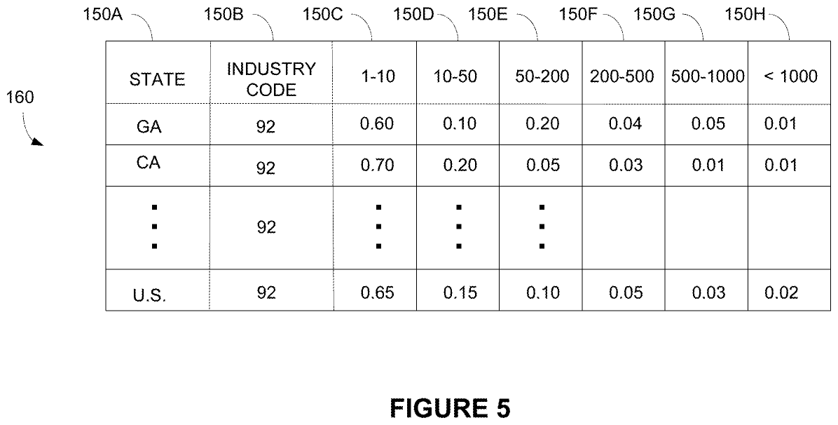

Referring to FIGS. 4 and 5, feature generator 108 generates probabilities 160 from census data 106. For example, feature generator 108 may generate a table 150 that includes state identifiers 150A, industry codes 150B, and different company size ranges 150C-150H. Feature generator 108 calculates probabilities 160 for each state 150A, industry code 150B, and company size range 150C-150H.

For example, feature generator 108 may add up the total number of companies with industry code 92 for the state of Georgia. Feature generator 108 may divide the number of companies in Georgia with industry code 92 and 1-10 employees by the total number of companies in Georgia with industry code 92. The resulting ratio 0.60 is used as a probability that a company in Georgia with industry code 92 has 1-10 employees. Feature generator 108 generates probabilities 160 for each state 150A, industry code 150B, and company size range 150C-150H. Feature generator 108 also may generate similar probabilities for the entire country. For example, feature generator 108 may divide the number of companies in the United States with industry code 92 and 1-10 employees by the total number of companies in the United States with industry code 92.

Feature generator 108 adds probabilities 160 as a feature to company profiles 112. For example, feature generator 108 may identify the industry code 150B and state contained in each company profile 112. As explained above, government filing data 102 and/or website data 104 may include business addresses and industry codes. Feature generator 108 then identifies the set of probabilities 160 for company size ranges 150C-150H with the same state 150A and industry code 150B. Feature generator 108 may convert the set of identified probabilities 160 into a six element vector and link the probability vector with matching company profiles 112.

The set of probabilities 160 are provided as inputs into employee number range predictor 118. Employee number range predictor 118 may use probabilities 160 during a training phase or during normal operation while predicting employee number ranges 122 in FIG. 1. For example, predictor 118 use the company size range with the highest probability value 160 as an initial guess. Predictor 118 also may adjust the probabilities 124 in FIG. 1 based on the corresponding prior knowledge probabilities 160 derived from census data 106.

CSE system 100 uses a novel scheme for estimating company employment size which incorporates publically available information in heterogeneous government and web data sources. CSE system 100 also scales well to datasets with millions of companies and can be used for estimating the size of U.S. companies or companies in other countries.

### Hardware and Software

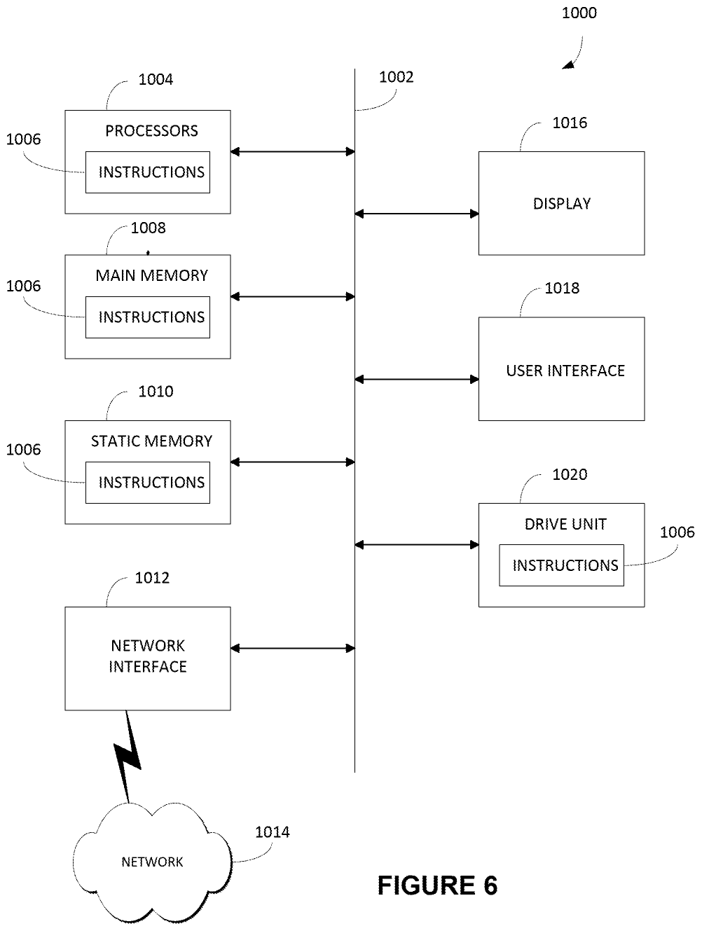

FIG. 6 shows a computing device 1000 that may be used for operating CSE system 100 and performing any combination of operations discussed above. The computing device 1000 may operate in the capacity of a server or a client machine in a server-client network environment, or as a peer machine in a peer-to-peer (or distributed) network environment. In other examples, computing device 1000 may be a dedicated server with optional GPU support hosted within a cloud infrastructure, personal computer (PC), a tablet, a Personal Digital Assistant (PDA), a cellular telephone, a smart phone, a web appliance, or any other machine or device capable of executing instructions 1006 (sequential or otherwise) that specify actions to be taken by that machine.

While only a single computing device 1000 is shown, the computing device 1000 may include any collection of devices or circuitry that individually or jointly execute a set (or multiple sets) of instructions to perform any one or more of the operations discussed above. Computing device 1000 may be part of an integrated control system or system manager, or may be provided as a portable electronic device configured to interface with a networked system either locally or remotely via wireless transmission.

Processors 1004 may comprise a central processing unit (CPU), a graphics processing unit (GPU), programmable logic devices, dedicated processor systems, micro controllers, or microprocessors that may perform some or all of the operations described above. Processors 1004 may also include, but may not be limited to, an analog processor, a digital processor, a microprocessor, multi-core processor, processor array, network processor, etc.

Some of the operations described above may be implemented in software and other operations may be implemented in hardware. One or more of the operations, processes, or methods described herein may be performed by an apparatus, device, or system similar to those as described herein and with reference to the illustrated figures.

Processors 1004 may execute instructions or “code” 1006 stored in any one of memories 1008, 1010, or 1020. The memories may store data as well. Instructions 1006 and data can also be transmitted or received over a network 1014 via a network interface device 1012 utilizing any one of a number of well-known transfer protocols.

Memories 1008, 1010, and 1020 may be integrated together with processing device 1000, for example RAM or FLASH memory disposed within an integrated circuit microprocessor or the like. In other examples, the memory may comprise an independent device, such as an external disk drive, storage array, or any other storage devices used in database systems. The memory and processing devices may be operatively coupled together, or in communication with each other, for example by an I/O port, network connection, etc. such that the processing device may read a file stored on the memory.

Some memory may be “read only” by design (ROM) by virtue of permission settings, or not. Other examples of memory may include, but may be not limited to, WORM, EPROM, EEPROM, FLASH, etc. which may be implemented in solid state semiconductor devices. Other memories may comprise moving parts, such a conventional rotating disk drive. All such memories may be “machine-readable” in that they may be readable by a processing device.

“Computer-readable storage medium” (or alternatively, “machine-readable storage medium”) may include all of the foregoing types of memory, as well as new technologies that may arise in the future, as long as they may be capable of storing digital information in the nature of a computer program or other data, at least temporarily, in such a manner that the stored information may be “read” by an appropriate processing device. The term “computer-readable” may not be limited to the historical usage of “computer” to imply a complete mainframe, mini-computer, desktop, wireless device, or even a laptop computer. Rather, “computer-readable” may comprise storage medium that may be readable by a processor, processing device, or any computing system. Such media may be any available media that may be locally and/or remotely accessible by a computer or processor, and may include volatile and non-volatile media, and removable and non-removable media.

Computing device 1000 can further include a video display 1016, such as a liquid crystal display (LCD) or a cathode ray tube (CRT) and a user interface 1018, such as a keyboard, mouse, touch screen, etc. All of the components of computing device 1000 may be connected together via a bus 1002 and/or network.

For the sake of convenience, operations may be described as various interconnected or coupled functional blocks or diagrams. However, there may be cases where these functional blocks or diagrams may be equivalently aggregated into a single logic device, program or operation with unclear boundaries.

Having described and illustrated the principles of a preferred embodiment, it should be apparent that the embodiments may be modified in arrangement and detail without departing from such principles. Claim is made to all modifications and variation coming within the spirit and scope of the following claims.

1. A computer program stored on a non-transitory storage medium, the computer program comprising a set of instructions, when executed by a hardware processor, cause the hardware processor to:
receive data associated with different companies from government filings and websites;
generate features associated with the companies from the data;
combine the features associated with the same companies into company profiles; and
use one or more machine learning models to predict sizes of the companies based on the company profiles.

2. The computer program of claim 1, wherein the set of instructions, when executed by a hardware processor, further cause the hardware processor to:
use a first machine learning model to predict which of the companies are above a selected employee threshold value; and
use a second machine learning model to predict different employee number ranges for the companies below the selected employee threshold value.

3. The computer program of claim 2, wherein the first machine learning model is a binary output decision tree model and the second machine learning model is of linear regression model.

4. The computer program of claim 1, wherein one of the features generated from the data identifies when the company was founded.

5. The computer program of claim 1, wherein one of the features generated from the data is associated with a number of visitors to websites operated by the company.

6. The computer program of claim 1, wherein one of the features generated from the data identifies different social media websites joined by the company.

7. The computer program of claim 1, wherein one of the features generated from the data is associated with a number of government filings by the company.

8. The computer program of claim 1, wherein one of the features generated from the data is associated with a number of website domains owned by the company.

9. The computer program of claim 1, wherein one of the features generated from the data is associated with a number of business addresses for the company.

10. The computer program of claim 1, wherein one of the features generated from the data is associated with a number of other companies that share a same business address with the company.

11. The computer program of claim 1, wherein one of the features generated from the data is associated with a number of software applications, types of software applications, or costs of software applications used on the websites operated by the company.

12. The computer program of claim 1, wherein one of the features generated from the data is associated with types of webpages on the websites operated by the company.

13. The computer program of claim 1, wherein the set of instructions, when executed by a hardware processor, further cause the hardware processor to:
generate vector representations of text located in webpages on websites operated by the company; and
use the vector representations as one of the features used in the company profiles to predict the size of the companies.

14. The computer program of claim 1, wherein the set of instructions, when executed by a hardware processor, further cause the hardware processor to:
receive census data;
identify industry classifications in the census data;
identify employee number ranges for each of the company classifications;
convert the employee number ranges for the industry classifications into probabilities; and
use the probabilities as features in the company profiles with matching industry classifications for predicting the sizes of the companies.

15. An apparatus for predicting company sizes, comprising:
a processing device;
a memory device coupled to the processing device, the memory device having instructions stored thereon that, in response to execution by the processing device, are operable to:
identify websites operated or used by companies and government filing by the companies;
identify characteristics of the websites and government filings that relate to employee sizes of the companies;
generate features from the characteristics of the websites and government filings;
combine the features for the same companies into company profiles; and
use the company profiles to predict employee number ranges for the companies.

16. The apparatus of claim 15, wherein the instructions in response to execution by the processing device, are further operable to input the company profiles into one of more machine learning models to predict the employee number ranges.

17. The apparatus of claim 15, wherein the instructions in response to execution by the processing device, are further operable to:
identify a number of government filings by the companies; and
use the number of government filings as one of the features in the company profiles.

18. The apparatus of claim 15, wherein the instructions in response to execution by the processing device, are further operable to:
identify a number of website domains operated by the companies; and
use the number of website domains as one of the features in the company profiles.

19. The apparatus of claim 15, wherein the instructions in response to execution by the processing device, are further operable to:
identify a number of different business addresses for the same companies; and
use the number of different business addresses as one of the features in the company profiles.

20. The apparatus of claim 15, wherein the instructions in response to execution by the processing device, are further operable to:
identify for the companies a number of other companies that share a same business address; and
use the number of other companies that share a same business address as one of the features in the company profiles.

21. The apparatus of claim 15, wherein the instructions in response to execution by the processing device, are further operable to:
identify types of software applications used on the websites operated by the companies; and
use the types of software applications as one of the features in the company profiles.

22. The apparatus of claim 15, wherein the instructions in response to execution by the processing device, are further operable to:
identify types of webpages in the websites operated by the companies; and
use the types of webpages as one of the features in the company profiles.

23. The apparatus of claim 15, wherein the instructions in response to execution by the processing device, are further operable to:
generate vector representations for text located in webpages on the websites operated by the companies; and
use the vector representations as one of the features used in the company profiles.

24. The apparatus of claim 15, wherein the instructions in response to execution by the processing device, are further operable to:
identify industry classifications in the census data;
identify employee number ranges for each of the company classifications;
convert the employee number ranges for the industry classifications into probabilities; and
use the probabilities as features in the company profiles.
